(19) United States
(12) Patent Application Publication
(10) Pub. No.: US 2022/0235529 A1
(43) Pub. Date: Jul. 28, 2022

(54) SNOW-CLEARING TRAILER WITH MEANS FOR DETECTING A THIRD-PARTY VEHICLE

(71) Applicant: SOVIAR, Passy (FR)

(72) Inventor: Michel Benedetti, Passy (FR)

(21) Appl. No.: 17/579,815

(22) Filed: Jan. 20, 2022

(30) Foreign Application Priority Data
Jan. 28, 2021 (FR) 21 00788

(51) Int. Cl. E01H 5/06; B62D 13/00; B62D 13/02; B60W 50/14

(52) U.S. Cl. CPC E01H 5/068; B62D 13/005; B62D 13/02; B60W 50/14; B60W 2050/143; B60W 2300/14; B60W 2420/403; B60W 2420/54; B60W 2510/20; B60W 2554/80; B60W 2050/146

(57) ABSTRACT

Pivoting snow-clearing trailer (1) intended to be towed by a towing vehicle (3) with a towing hitch (4), comprising:
a chassis (5) extending longitudinally in a chassis direction (I-I) between a chassis anterior end (5a) and a chassis posterior end (5b), and developing transversely between a chassis first side (5c) and a chassis second side (5d) which are opposite one another,
a snow-clearing blade (6) borne along the chassis first side (5c).

Detection means (10) are able to generate a presence signal when the snow-clearing trailer (1) is pivoted and when an object or an individual is stationed in an area (A1) to the side and/or an area (A2) to the rear of the chassis second side (5d).

### TECHNICAL FIELD OF THE INVENTION

The present invention relates to the clearing of snow from road carriageways and relates more particularly to a snow-clearing trailer intended to be towed by a vehicle with a towing hitch.

In order to clear snow from several lanes of a carriageway simultaneously using a single towing vehicle, a snow-clearing trailer such as described in document US 2006/0143952 A1 and comprising:
a chassis extending longitudinally in a chassis direction between a chassis anterior end and a chassis posterior end, and developing transversely between a chassis first side and a chassis second side which are opposite one another,
a snow-clearing blade borne along the chassis first side,
at least one wheel designed to support the chassis on the ground, an axle of said wheel being selectively orientable by orientation means between a first wheel position, in which an axis of the axle about which the wheel rotates is perpendicular to the chassis direction, and at least a second wheel position, in which the axis of the axle about which the wheel rotates makes with the chassis direction an axle angle greater than 90°,
a drawbar able to connect the chassis anterior end to the towing hitch of the towing vehicle,

is known.

Another snow-clearing trailer is described in document EP 3 196 361 A1.

Document U.S. Pat. No. 9,944,318 B2 describes a system for steering the rear wheels and which is suited for use on an automated vehicle, since a system comprising an object detector, an actuator and a controller. In a bend, the object detector is used to detect any potential object that might be situated near the side of the vehicle and only on the inside of the bend. If an object is detected, the actuator is used to adjust a rear steering angle of the rear wheels of the vehicle in order to avoid the object when the host vehicle moves.

In the second position of the wheel, the snow-clearing trailer is offset laterally and oriented obliquely with respect to the direction of travel of the towing vehicle.

It is found that certain drivers of third-party vehicles have a tendency to wish to attempt to pass snow-clearing vehicles. In this instance, particularly in conditions of poor visibility, some move up until they are alongside the trailer and arrive just behind the towing vehicle. The result of this is that the trailer may then cut across the third-party vehicle and sweep it aside if said at least one wheel is brought back at an inopportune moment from its second position to its first wheel position, for example on a command by the driver of the towing vehicle.

### SUMMARY OF THE INVENTION

A problem that the present invention proposes to address is that of limiting the risk when the snow-clearing trailer is oriented obliquely with respect to the direction of travel of the towing vehicle through actuation of the means used to orient said at least one wheel.

In order to achieve these objectives as well as others, the invention proposes a snow-clearing trailer intended to be towed by a towing vehicle with a towing hitch, said snow-clearing trailer comprising:
a chassis extending longitudinally in a chassis direction between a chassis anterior end and a chassis posterior end, and developing transversely between a chassis first side and a chassis second side which are opposite one another,
a snow-clearing blade borne along the chassis first side,
at least one wheel designed to support the chassis on the ground, an axle of said wheel being selectively orientable by orientation means between a first wheel position, in which an axis of the axle about which the wheel rotates is perpendicular to the chassis direction, and at least a second wheel position, in which the axis of the axle about which the wheel rotates makes with the chassis direction an axle angle greater than 90°,
a drawbar able to connect the chassis anterior end to the towing hitch of the towing vehicle,

said snow-clearing vehicle according to the invention further comprising detection means able to generate a presence signal when:
the wheel is in a second wheel position, and
an object or an individual is stationed in an area to the side and/or an area to the rear of the chassis second side.

With such a snow-clearing trailer according to the invention, the presence signal alerts the driver of the towing vehicle so that they can refrain from actuating the orientation means for the reason that there is a third-party vehicle in a dangerous position (namely in the area to the side and/or the area to the rear of the chassis second side) with respect to the snow-clearing trailer. As an alternative or in addition, the presence signal may be used to alert the driver of the third-party vehicle to the fact that they are in a dangerous position so that they move away from the towing vehicle and from the snow-clearing trailer.

Advantageously, provision may be made that:
said snow-clearing trailer comprises disabling means able to disable the orientation means,
the disabling means and the detection means are arranged in such a way that when the wheel is in a second wheel position and when the detection means are generating a presence signal, the disabling means prevent any actuation of the orientation means that might tend to orient the axle from the second wheel position into the first wheel position.

Actuation of the orientation means is thus rendered impossible when the detection means detect a third-party vehicle placed in a dangerous position (namely in the area to the side and/or the area to the rear of the chassis second side). Thus, safety is ensured even if the driver of the towing vehicle is inattentive.

In practice, the area to the side of the chassis second side may advantageously comprise at least part of the angular sector that the chassis second side has to cut across in order for the axle to move from the second wheel position into the first wheel position.

In practice, the area to the rear of the chassis second side may advantageously lie at a distance shorter than a predetermined distance from the posterior end of the chassis second side.

As a preference, the snow-clearing trailer may comprise warning means able to generate a warning signal perceivable by an individual detected by the detection means, preferably a visual and/or audible warning signal, when the detection means generate a presence signal.

The presence signal is thus used to alert the driver of the third-party vehicle to the fact that they are in a dangerous position, so that they can move away from the towing vehicle and from the snow-clearing trailer.

Advantageously, the detection means comprise at least an ultrasound sensor. The detection means thus have a structure that is simple and easy to install and to adjust, like the parking aid devices used in motor vehicles.

As a preference, provision may be made that:
the detection means comprise a sensor positioned in the vicinity of the posterior end of the chassis second side,
said sensor is designed to detect an object or an individual around a mean detection direction oriented obliquely away from the chassis second side and from the chassis anterior end.

Such orientation of the sensor allows an area to the side and/or an area to the rear of the chassis second side to be monitored in a simple way.

Advantageously, the detection means generate a presence signal if a detected object or individual is stationed, with respect to the sensor, at a distance that is smaller than a maximum distance that is an increasing function of the axle angle.

By thus adapting the detection distance of the sensor according to the axle angle, the generation of ill-timed presence signals (or even the disabling of the controls for the orientation means) is avoided when it is the crash barrier at the side of the roadway that is detected.

In order to avoid this problem of detecting the crash barrier at the side of the roadway, it is alternatively possible to make provision that:
the detection means do not generate a presence signal when the axle angle is smaller than a predetermined minimum angle value, or
the presence signals are disabled when the axle angle is smaller than said predetermined minimum angle value.

The fact that no presence signal is generated or that the presence signals are disabled when the axle angle is small is not excessively detrimental: a third-party vehicle would in any case not have enough space to approach and station itself in the area to the side.

Another aspect of the present invention proposes a snow-clearing assembly comprising:
a towing vehicle,
a snow-clearing trailer as described hereinabove,
alarm means able to generate an alarm signal perceivable by an operator stationed in the driving cab of the towing vehicle, preferably a visual and/or audible alarm signal, when the detection means generate a presence signal.

The driver of the towing vehicle is thus reliably alerted so that they refrain from actuating the orientation means for the reason that there is a third-party vehicle in a dangerous position (namely in the area to the side and/or the area to the rear of the chassis second side) with respect to the snow-clearing trailer.

The use of a visual and/or audible alarm signal is preferred because the driver of the towing vehicle has a great deal of things to monitor: the correct road holding and course of the towing vehicle on the roadway, the course of the snow-clearing trailer with respect to the edge of the roadway, the orientation of the snow-clearing blade that the towing vehicle generally has mounted on it, any substances that need to be spread on the roadway (salt, grit, etc.), and the possible presence of obstacles on the roadway or at the edges of the roadway, etc.

As a preference, the alarm means comprise:
camera means oriented over an area to the side and/or an area to the rear which is at least partially situated near the chassis second side,
display means, arranged in the driving cab of the towing vehicle and able to receive and display images coming from the camera means.

The camera means provide the driver of the towing vehicle with a clear view of events occurring in the area to the side and/or the area to the rear of the chassis second side.

Advantageously, the displaying of the images by the display means may be triggered only when the detection means are generating a presence signal, the reason for this being so as not to needlessly distract the driver who already has a great many things to monitor.

Another aspect of the present invention proposes the use of a snow-clearing trailer as described hereinabove or of a snow-clearing assembly as described hereinabove, in which use the detection means monitor the area to the side and/or the area to the rear of the chassis second side only when the wheel is in a second wheel position. Thus, monitoring is performed (and a presence signal generated) only when there is a risk of a third-party vehicle or a third-party individual entering the area to the side or the area to the rear. This then limits the risks of needless alerts.

Another aspect of the present invention proposes the use of a snow-clearing trailer as described hereinabove or of a snow-clearing assembly as described hereinabove, in which use the detection means monitor the sides of the chassis only in the area to the side comprising at least part of the angular sector that the chassis second side has to cut across in order for the axle to move from the second wheel position to the first wheel position. Monitoring is thus performed only on the side that matters. There is no detection on the other (first) side of the chassis in order not to mislead the operator through an excess of presence signals.

### BRIEF DESCRIPTION OF THE DRAWINGS

Further objects, features and advantages of the present invention will become apparent from the following description of some particular embodiments, which is given with reference to the attached figures among which:

FIG. 1 is a schematic view from above of a snow-clearing assembly comprising a snow-clearing trailer according to the present invention, of which said at least one wheel is in the first wheel position;

FIG. 2 is a schematic view from above of part of the snow-clearing trailer of the snow-clearing assembly of FIG. 1;

FIG. 3 is a schematic view from above of a snow-clearing assembly with the snow-clearing trailer, of which said at least one wheel is in the second wheel position;

FIG. 4 is a schematic view from above of part of the snow-clearing trailer of the snow-clearing assembly of FIG. 3; and

FIG. 5 is a schematic view illustrating the operation of the detection means of the snow-clearing trailer.

### DESCRIPTION OF THE PREFERRED EMBODIMENTS

Where identical numerical references are used in a number of embodiments of the invention, these numerical references refer to elements which are identical or similar in each of the embodiments.

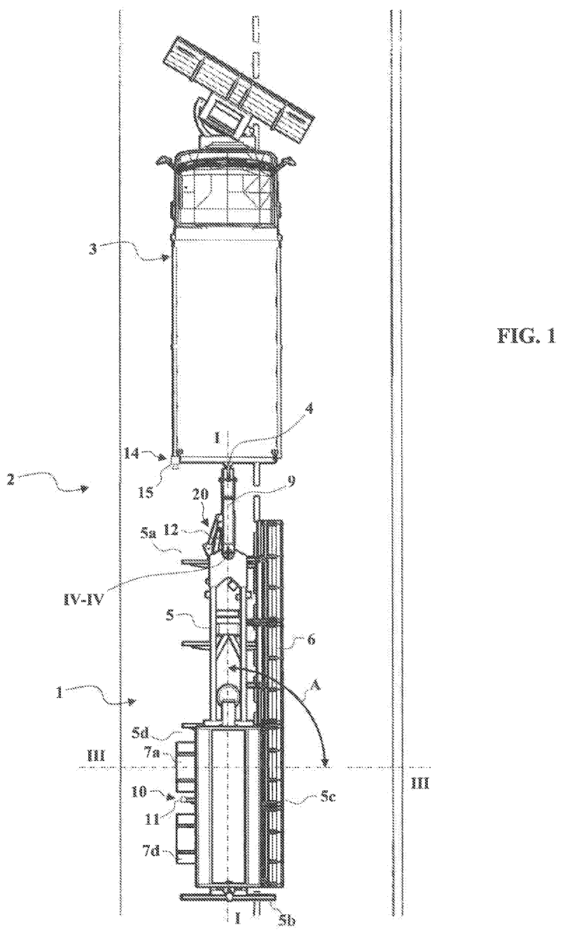

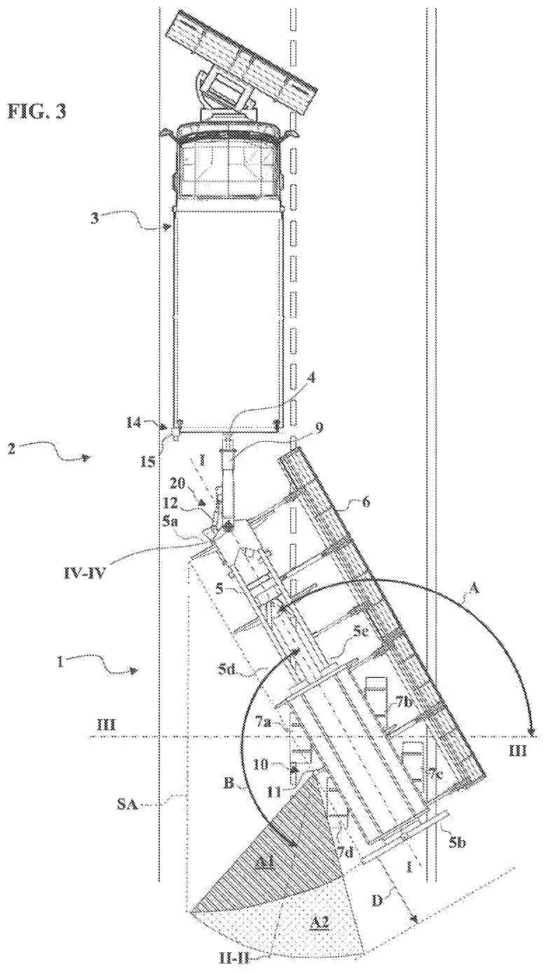

FIGS. 1 to 5 illustrate one exemplary embodiment of a snow-clearing trailer 1 according to the present invention, which is used in a snow-clearing assembly 2 in FIGS. 1 and 3, which further comprises a towing vehicle 3 for towing it.

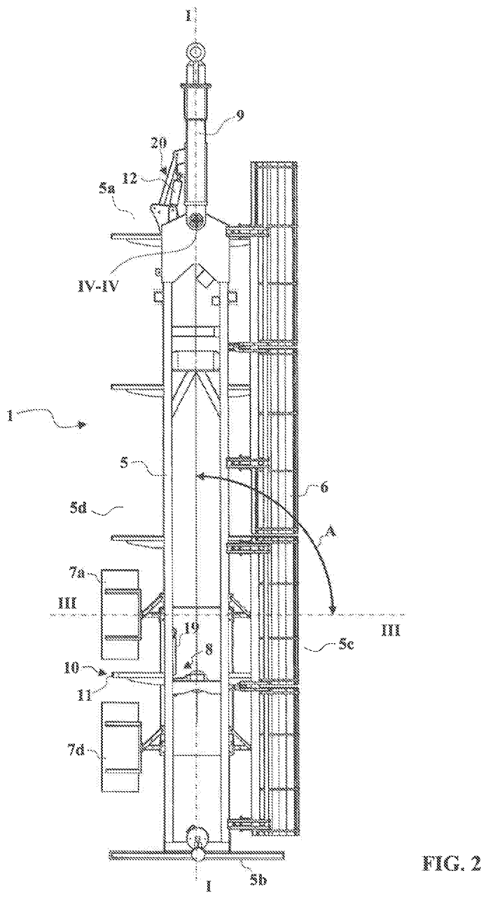

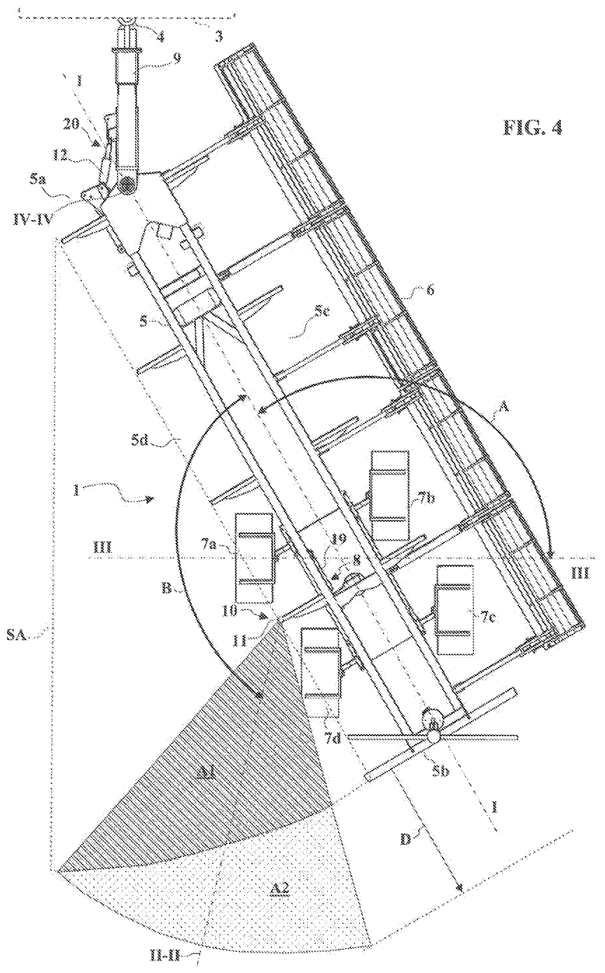

The snow-clearing trailer is of the type able to pivot between a transport position (FIGS. 1 and 2) and a snow-clearing position (FIGS. 3 and 4) as described for example in documents US 2006/0143952 A1 and EP 3 196 361 A1.

The snow-clearing trailer 1 is intended to be towed by the towing vehicle 3 with a towing hitch 4. Said snow-clearing trailer 1 comprises:
a chassis 5 extending longitudinally in a chassis direction I-I between a chassis anterior end 5a and a chassis posterior end 5b, and developing transversely between a chassis first side 5c and a chassis second side 5d which are opposite one another,
a snow-clearing blade 6 borne along the chassis first side 5c,
four wheels 7a to 7d designed to support the chassis 5 on the ground, the axles of the wheels 7a to 7d being selectively orientable by orientation means 8 between a first wheel position (FIGS. 1 and 2), in which the axes of the axles about which the wheels 7a to 7d rotate are perpendicular to the chassis direction I-I (FIGS. 1 and 2), and at least a second wheel position (FIGS. 3 and 4), in which the axes of the axles about which the wheels 7a to 7d rotate make with the chassis direction I-I an axle angle A different than (greater than) 90° (FIGS. 3 and 4),
a drawbar 9 able to connect the chassis anterior end 5a to the towing hitch 4 of the towing vehicle 3.

The orientation means 8 notably comprise a double acting hydraulic cylinder 19 more particularly visible in FIGS. 2 and 4.

In this instance, the snow-clearing trailer 1 is similar to the one described in document EP 3 196 361 A1, with a drawbar 9 articulated with pivoting with respect to the chassis anterior end 5a about a direction IV-IV which is perpendicular to the plane defined by the chassis direction I-I and the direction in which the slow-clearing trailer 1 develops transversely between a chassis first side 5c and a chassis second side 5d. Pivoting means 20 allow the chassis 5 to be moved selectively in pivoting with respect to the drawbar 9 and the relative angular position of the chassis 5 and of the drawbar 9 to be fixed as can be seen by comparing FIGS. 1 and 2 with FIGS. 3 and 4. The pivoting means 20 notably comprise a double-acting hydraulic cylinder 12 more particularly visible in FIGS. 2 and 4.

The snow-clearing trailer 1 comprises detection means 10 able to generate a presence signal when:
the wheels 7a to 7d are in a second wheel position, and
an object or an individual is stationed in an area A1 to the side and/or an area A2 to the rear of the chassis second side 5d.

It may be seen more particularly in FIGS. 3 and 4 that the area A1 to the side of the chassis second side comprises at least part of the angular sector SA (the contours of which are marked in broken line) that the chassis second side 5d has to cut across in order for the axle to move from the second wheel position (FIGS. 3 and 4) to the first wheel position (FIGS. 1 and 2).

Furthermore, it may be seen that the area A2 to the rear of the chassis second side 5d lies at a distance less than a predetermined distance D from the posterior end of the chassis second side 5d.

If a third-party vehicle attempts to enter the angular sector SA, this is at minimum detected by the detection means 10 when it enters the area A1. Here, the third-party vehicle is even detected even before it comes alongside the chassis second side 5d, as soon as it enters the area A2 to the rear. Thus, in the absence of a presence signal, the orientation means 8 can be actuated without concern, with no risk to a third-party vehicle. If a third-party vehicle enters one of the areas A1 and A2, it is detected, and the driver of the towing vehicle may be alerted so that they do not actuate the orientation means 8.

In one particular embodiment, the snow-clearing trailer 1 comprises disabling means able to disable the orientation means 8. The disabling means and the detection means 10 are then arranged in such a way that when the wheels 7a to 7d are in a second wheel position and when the detection means 10 are generating a presence signal, the disabling means prevent any actuation of the orientation means 8 that might tend to orient the axles from the second wheel position (FIGS. 3 and 4) to the first wheel position (FIGS. 1 and 2). Any movement of the snow-clearing trailer 1 liable to cause it to collide with the third-party vehicle is thus prevented.

In the embodiment illustrated in the figures, the detection means 10 comprise at least an ultrasound sensor 11 (FIGS. 3 and 4) like those used in the automotive sector for parking aids (also sometimes commonly referred to as “reversing radar”).

The sensor 11 is positioned in the vicinity of the posterior end of the chassis second side 5d (a little further forward along the chassis direction I-I, toward the chassis anterior end 5a). Said sensor 11 is designed to detect an object or an individual about a detection mean direction II-II directed obliquely away from the chassis second side 5d and from the chassis anterior end 5a. Here, the detection mean direction II-II makes an angle B with the chassis direction I-I of between 90° and 180°.

It is important that the movement of the snow-clearing trailer 1 (or the driver of the towing vehicle 3 who is maneuvering the snow-clearing trailer 1) is not disturbed by inappropriate detection of a crash barrier bordering the roadway on the side of the chassis second side 5d.

In order to achieve this, a first possibility is to make provision for the detection means 10 to generate a presence signal if a detected object or individual is stationed, with respect to the sensor 11, at a distance shorter than a maximum distance DMax that is an increasing function of the axle angle A. In other words, the range at which an object or an individual can be detected is decreased as the axle angle A tends back toward 90° (and therefore as the snow-clearing trailer 1 returns to the continuation of the path of the towing vehicle 3).

A second possibility is to make provision for the presence signals to be disabled when the axle angle A is smaller than a predetermined minimum angle Amin.

A third possibility, which is preferred here and employed in the embodiment of FIGS. 1 to 5, is to make provision for the detection means 10 not to generate a presence signal when the axle angle A is smaller than a predetermined minimum angle value Amin.

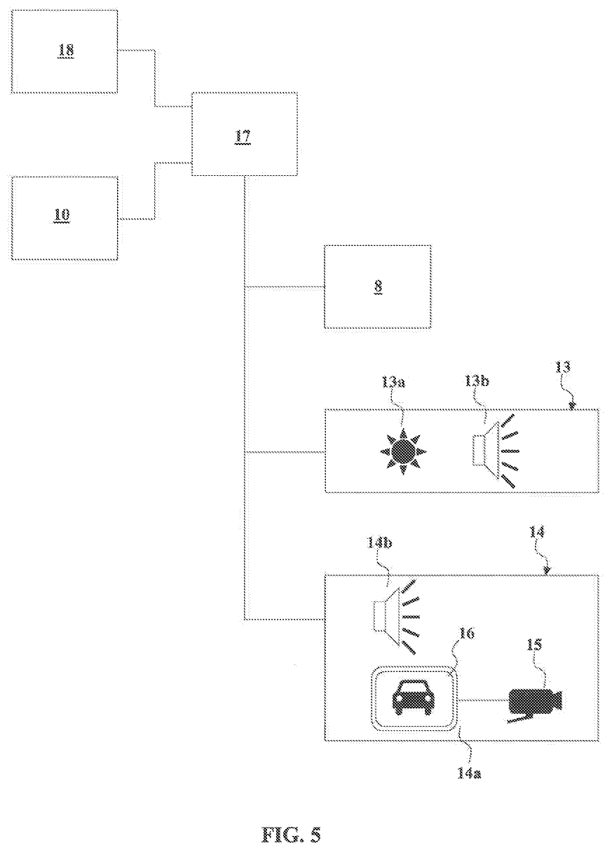

FIG. 5 schematically illustrates:
warning means 13 able to generate a warning signal perceivable by an individual detected by the detection means 10. In this case, the warning means 13 comprise a visual warning signal generator 13a (a flashing or fixed light) and an audible warning signal generator 13b which respectively generate a visual signal and an audible signal when the detection means 10 are generating a presence signal. The warning means are borne by the snow-clearing trailer 1;
alarm means 14, able to generate an alarm signal perceivable by an operator in the driving cab of the towing vehicle 3. In practice, the alarm means 14 comprise a visual warning signal generator 14a and an audible warning signal generator 14b which respectively generate a visual signal and an audible signal when the detection means 10 are generating a presence signal.

In this instance, in order to generate a visual warning signal, the alarm means 14 comprise:
camera means 15 oriented over an area Al to the side and/or an area A2 to the rear which is at least partially situated near the chassis second side 5d. The camera means 15 are borne by the towing vehicle 3. Alternatively, they could be borne by the snow-clearing trailer 1;
display means 16, arranged in the driving cab of the towing vehicle 3 and able to receive and display images coming from the camera means 15.

The displaying of the images by the display means 16 may be triggered only when the detection means 10 are generating a presence signal, the reason for this being so as not to needlessly distract the driver who already has a great many things to monitor.

FIG. 5 also includes control means 17 and measuring means 18 for respectively controlling and measuring the axle angle A. The axle angle A may be measured in various ways, for example by measuring the stroke of the hydraulic cylinder 19.

The way in which the snow-clearing trailer 1 operates will now be explained in connection with FIGS. 1 to 5.

The snow-clearing trailer 1 is initially towed behind the towing vehicle 3 (transport position) with an axle angle A of 90°: the axes of axles about which the wheels 7a to 7d rotate are parallel to a direction III-III and make with the chassis direction I-I an axle angle A which is equal to 90°.

When there is snow to be cleared, the orientation means 8 are operated in such a way as to increase the axle angle A in order to bring the wheels 7a to 7d toward the second wheel position (FIGS. 3 and 4—snow-clearing position of the snow-clearing trailer 1): the axes of the axles about which the wheels 7a to 7d rotate are parallel to a direction III-III and make with the chassis direction I-I an axle angle A which is greater than 90°. The snow-clearing blade 6 is simultaneously or subsequently lowered into contact with the roadway.

Upward of a predetermined axle angle Amin (in practice, as soon as enough space is created for a third-party vehicle to be able to squeeze in alongside the chassis second side 5d) identified by the means 18 for measuring the axle angle A, the control means 17 activate the detection means 10.

According to another approach, the detection means 10 monitor the area Al to the side and/or the area A2 to the rear of the chassis second side 5d only when the wheels 7a-7d are in a second wheel position. Thus, the monitoring is performed (and a presence signal generated where appropriate) only when there is a risk of a third-party vehicle or a third-party individual entering the area Al to the side or the area A2 to the rear. This then limits the risk of needless alerts.

As illustrated in FIGS. 3 and 4, the detection means 10 monitor the sides of the chassis only in the area Al to the side comprising at least part of the angular sector SA that the chassis second side 5d has to cut across in order for the axle to move from the second wheel position to the first wheel position.

If a third-party vehicle imprudently approaches the snow-clearing trailer 1 and enters one and/or other of the areas Al and A2, the detection means generate a presence signal which is communicated to the control means 17.

The control means 17 then operate the warning means 13 which generate, for the attention of the driver of the third-party vehicle, a visual signal (illuminating a fixed or flashing light) by means of the visual warning signal generator 13a and generate an audible signal by means of the audible warning signal generator 13b.

At the same time, the control means 17 operate the alarm means 14 to alert the driver in the cab of the towing vehicle 3 to the presence of the third-party vehicle:
the audible warning signal generator 13b emits an audible signal, and
the camera means 15 transmit images which the display means 16 display.

The driver of the towing vehicle 3, duly alerted to the presence of the third-party vehicle, then refrains from any actuation of the orientation means 8 that tends to orientate the axle from the second wheel position (FIGS. 3 and 4) to the first wheel position (FIGS. 1 and 2). A collision with the third-party vehicle is thus avoided.

When the snow-clearing operations have been completed, or when an obstacle has to be overcome, the driver of the towing vehicle actuates the orientation means in the direction that tends to orientate the axle from the second wheel position (FIGS. 3 and 4) to the first wheel position (FIGS. 1 and 2) in order to return the snow-clearing trailer 1 to the transport position. If there is no object or individual in the areas A1 and A2, the detection means do not emit any presence signal. Furthermore, below said predetermined axle angle Amin identified by the means 18 for measuring the axle angle A, the control means 17 deactivate the detection means 10 so that the snow-clearing trailer completes its return to the transport position illustrated in FIGS. 1 and 2 without any inadvertent detection of the crash barrier bordering the roadway troubling the driver and/or the maneuver of the snow-clearing trailer 1.

The present invention is not restricted to the embodiments that have been explicitly described but rather includes the diverse variants and generalizations thereof that are contained within the scope of the claims which follow.

1. A snow-clearing trailer (1) intended to be towed by a towing vehicle (3) with a towing hitch (4), said snow-clearing trailer (1) comprising:
a chassis (5) extending longitudinally in a chassis direction (I-I) between a chassis anterior end (5a) and a chassis posterior end (5b), and developing transversely between a chassis first side (5c) and a chassis second side (5d) which are opposite one another,
a snow-clearing blade (6) borne along the chassis first side (5c),
at least one wheel (7a-7d) designed to support the chassis (5) on the ground, an axle of said wheel (7a-7d) being selectively orientable by orientation means (8) between a first wheel position, in which an axis of the axle about which the wheel (7a-7d) rotates is perpendicular to the chassis direction (I-I), and at least a second wheel position, in which the axis of the axle about which the wheel (7a-7d) rotates makes with the chassis direction (I-I) an axle angle (A) greater than 90°,
a drawbar (9) able to connect the chassis anterior end (5a) to the towing hitch (4) of the towing vehicle (3),
wherein said snow-clearing trailer (1) comprises detection means (10) able to generate a presence signal when:
the wheel (7a-7d) is in a second wheel position, and
an object or an individual is stationed in an area (A1) to the side and/or an area (A2) to the rear of the chassis second side (5d).

2. The snow-clearing trailer (1) as claimed in claim 1, wherein:
said snow-clearing trailer (1) comprises disabling means able to disable the orientation means (8),
the disabling means and the detection means (10) are arranged in such a way that when the wheel (7a-7d) is in a second wheel position and the detection means (10) are generating a presence signal also, the disabling means prevent any actuation of the orientation means (8) that might tend to orient the axle from the second wheel position into the first wheel position.

3. The snow-clearing trailer (1) as claimed in claim 1, wherein the area (A1) to the side of the chassis second side (5d) comprises at least part of the angular sector (SA) that the chassis second side (5d) has to cut across in order for the axle to move from the second wheel position into the first wheel position.

4. The snow-clearing trailer (1) as claimed in claim 1, wherein the area (A2) to the rear of the chassis second side (5d) lies at a distance shorter than a predetermined distance (D) from the posterior end of the chassis second side (5d).

5. The snow-clearing trailer (1) as claimed in claim 1, wherein it comprises warning means (13) able to generate a warning signal perceivable by an individual detected by the detection means (10), preferably a visual and/or audible warning signal, when the detection means (10) generate a presence signal.

6. The snow-clearing trailer (1) as claimed in claim 1, wherein the detection means (10) comprise at least an ultrasound sensor (11).

7. The snow-clearing trailer (1) as claimed in claim 1, wherein:
the detection means (10) comprise a sensor (11) positioned in the vicinity of the posterior end of the chassis second side (5d),
said sensor (11) is designed to detect an object or an individual around a mean detection direction (II-II) oriented obliquely away from the chassis second side (5d) and from the chassis anterior end (5a).

8. The snow-clearing trailer (1) as claimed in claim 7, wherein the detection means (10) generate a presence signal if a detected object or individual is stationed, with respect to the sensor (11), at a distance that is smaller than a maximum distance that is an increasing function of the axle angle (A).

9. The snow-clearing trailer (1) as claimed in claim 1, wherein:
the detection means (10) do not generate a presence signal when the axle angle (A) is smaller than a predetermined minimum angle value (Amin), or
the presence signals are disabled when the axle angle (A) is smaller than said predetermined minimum angle value (Amin).

10. A snow-clearing assembly (2) comprising:
a towing vehicle (3),
a snow-clearing trailer (1) as claimed in claim 1,
alarm means (14) able to generate an alarm signal perceivable by an operator stationed in the driving cab of the towing vehicle (3), preferably a visual and/or audible alarm signal, when the detection means (10) generate a presence signal.

11. The snow-clearing assembly (2) as claimed in claim 10, wherein the alarm means (14) comprise:
camera means (15) oriented over an area (A1) to the side and/or an area (A2) to the rear which is at least partially situated near the chassis second side (5d),
display means (16), arranged in the driving cab of the towing vehicle (3) and able to receive and display images coming from the camera means (15).

12. The use of a snow-clearing trailer (1) as claimed in claim 1 or of a snow-clearing assembly (2) as claimed in claim 10, wherein the detection means (10) monitor the area (A1) to the side and/or the area (A2) to the rear of the chassis second side (5d) only when the wheel (7a-7d) is in a second wheel position.

13. The use as claimed in claim 12, wherein the area (A1) to the side of the chassis second side (5d) comprises at least part of the angular sector (SA) that the chassis second side (5d) has to cut across in order for the axle to move from the second wheel position to the first wheel position.

14. The use as claimed in claim 12, wherein the area (A2) to the rear of the chassis second side (5d) lies at a distance smaller than the predetermined distance (D) from the posterior end of the chassis second side (5d).

15. The use of a snow-clearing trailer (1) as claimed in claim 1 or of a snow-clearing assembly (2) as claimed in claim 10, wherein the detection means (10) monitor the sides of the chassis only in the area (A1) to the side comprising at least part of the angular sector (SA) that the chassis second side (5d) has to cut across in order for the axle to move from the second wheel position to the first wheel position.
